(19) United States
(12) Patent Application Publication
(10) Pub. No.: US 2021/0094227 A1
(43) Pub. Date: Apr. 1, 2021

(54) Extrusion deposition of non-polymers with laser trace

(71) Applicant: John Theodore Wigand, Nashua, NH (US)

(72) Inventor: John Theodore Wigand, Nashua, NH (US)

(21) Appl. No.: 16/586,926

(22) Filed: Sep. 28, 2019

(51) Int. Cl. B29C 64/165; B29C 64/135; B29C 64/20

(52) U.S. Cl. CPC B29C 64/165; B29C 2035/0838; B29C 64/20; B29C 64/135

(57) ABSTRACT

A computer controlled additive manufacturing process in which a non-polymer material and a non-polymer liquid binder are combined to form a paste that is extruded into the volume enclosed by the target model after which a laser beam of sufficient energy is guided along the same extrusion path to remove some portion of liquid binder, transition the material from paste form into solid form, and/or bond the material to surrounding material.

### BACKGROUND ART

| | | |
|---|---|---|
| 10,059,056 | Church, et al. | Micro-dispensing multi-layered 3D |
| | | objects with curing steps |
| 10,066,119 | Boydston, et al. | Method for solid freeform fabrication |
| 10,052,815 | Mark | Supports for sintering additively |
| | | manufactured parts |
| 10,052,691 | Heikkila | Surface modified particulate and |
| | | sintered or injection molded products |
| 9,944,021 | Easter, et al. | Additive manufacturing 3D printing of |
| | | advanced ceramics |
| 9,757,801 | Gunster, et al. | Method of producing a moulded body |
| | | and device |
| 8,329,092 | Fuwa, et al. | Metal powder for metal laser-sintering |
| | | and metal laser-sintering process |
| | | using the same |
| 6,531,191 | Notenboom | Method of manufacturing a sintered |
| | | structure on a substrate |
| 5,314,003 | Mackay | Three-dimensional metal fabrication |
| | | using a laser |

### Novelty of This Invention Relative to Background Art

U.S. Pat. No. 10,059,056—Church, et al.
   The Church et al. patent specifically claims using only polymer-based material.
   This application explicitly uses materials other than polymers.
U.S. Pat. No. 10,066,119—Boydston, et al.
   The Boydston et al. patent specifically claims applying a solvent to specific locations of a powder bed.
   This application does not use a powder bed or solvent.
U.S. Pat. No. 10,052,815—Mark
   The Mark patent specifically claims a method for generating supports for metal sintered parts.
   This application describes a technique for generically performing in-situ sintering of many materials.
U.S. Pat. No. 10,052,692—Heikkila
   The Heikkila patents specifically claims a process for the fabrication of metal nano-particles.
   This application describes a process for using metal micro-particles, not forming them.
U.S. Pat. No. 9,944,021—Easter, et al.
   The Easter et al. patent specifically claims a process of spraying each layer with resin.
   This application does not spray anything.
U.S. Pat. No. 9,757,801—Gunster et al.
   The Gunster et al. patent describes a process by which an entire layer of particle/binder material is deposited then dehumidified, then cut, scribed, or otherwise shaped into the desired geometry.
   This application forms the geometry as the particle/binder material is deposited.
U.S. Pat. No. 8,329,092—Fuwa et al.
   The Fuwa et al. patent specifically claims the use of entire metal powder layers being sintered by a laser beam to form geometry.
   This application does not use a laser to form geometry. Geometry is formed by the syringe paste extrusion and then followed by a laser to only alter what has already been deposited.
U.S. Pat. No. 6,531,191—Notenboom
   The Notenboom patent specifically claims the deposition process to be via ink jet printer.
   This application does not use an ink jet printer.
U.S. Pat. No. 5,314,003—Mackay
   The Mackay patent forms entire layers of metal film simultaneously via methods such as screen printing.
   This application forms layers from beads of material deposited by syringe extrusion.

### SUMMARY OF INVENTION

Additive manufacturing is a fabrication process in which a three-dimensional digital description of an object is cross-sectioned into a series of thin layers. Each layer is then printed on top of each other using a computer-controlled motion system. ISO/ASTM-2900-15 defines seven basic processes for additive manufacturing. This invention is a process that is a hybrid of two of them, material extrusion and directed energy deposition, yielding several distinct advantages over them.

This additive manufacturing machine (3D printer) process extrudes material paste out of a nozzle to form beads along the contours and interior of a digital design model. As the beads or deposited, a laser retraces the same tool path that was used to deposit the beads. The laser modifies the bead material in a manner dictated by the material that was deposited. Beads are combined to form layers. Layers are stacked to form a three-dimensional shape.

Beads are on the order of 0.020″ wide and 0.010″ thick and deposited at a rate of about 1.0 in/sec. These values vary dependent upon the consistency of material paste, the size of the nozzle, and the desired accuracy of deposition. Laser beam widths range from 0.020″ down to 0.005″ and are traced at rates dictated by the amount of heat required to modify the bead material. This trace speed can vary wildly from 0.10″/sec when melting metals to 100.0″/sec when just removing an alcohol binder.

The extruded material paste can consist of a wide range of non-polymer materials such as food, ceramic, or metal among others. Possible food-oriented model materials include such items as raw cake batter, puréed raw protein, puréed raw vegetables, or granules such as sugar or cornstarch within a binder such that the resulting paste can be extruded through a nozzle. In the food-oriented embodiment, the laser acts as a localized cooking element to modify the food bead in a specific manner. It may “cook” materials such as cake batter or raw protein, or it may “melt” sugars, or even “render” fatty substances.

In other embodiments, ceramic and metal model materials consist of a micron sized powder of the desired model material combined with a low volume fraction of liquid binder to form a viscous paste that can be extruded out of a nozzle. Ultimately, any variety of metal, any type of ceramic, or any stable solid material that can be made into a fine powder can be combined with binder to form a paste. The binder liquid is dependent upon the powdered material. Typically, for materials with a melting point that can be achieved by the tracing laser, a mildly lubricating fluid such as water, alcohol, flux, wax, or mineral oil can be used. For materials such as ceramic or tungsten whose melt points are beyond what a laser can achieve, the binder contains some portion of lower melt point material that melts to fuse the powder together. Typical volume fractions are in the order of 60% model material powder to 40% binder liquid up to 90% model material powder to 10% binder liquid, by weight. Viscosity must be less than 1 M centipoise, 500 k centipoise desired, and is driven by the shape of the micron sized powder thus requiring differing ratios of binder to achieve a low enough viscosity to extrude.

Although polymers could also be used as either the powder or the binder, this invention avoids their use in any embodiment as to not violate prior art (ref USPTO U.S. Pat. No. 10,059,056).

After the paste material is extruded from the nozzle, and before the next layer begins to be deposited, a laser re-traces the path of the extruder nozzle to melt, vaporize, burn off, or otherwise remove the binder and fuse the bead of remaining material from a powder to a solid, and to the material around it. Since the micron sized powder is contained within a binder until the localized heating of the laser strikes it there is no chance of powder explosion as there is with a free-standing bed of powder making this process far safer than existing selective laser sintering methods. Having the material powder encased in binder also prevents the material powder from reacting to its environment in the way metal powder oxidizes. By removing some portion of the liquid binder from the powder as the powder is fused together, environmental exposure is mitigated thus simplifying the equipment and improving resulting model quality.

Even if a post processing step, such as sintering, is required to fuse the powdered material together, there is benefit in removing as much of the liquid binder from the paste prior to post processing to purify the resulting object. Thus there is benefit to tracing the laser over deposited paste even if the energy of the laser is not sufficient to fuse the powder together. The laser energy only has to be sufficient in helping to vaporize the liquid binder.

Yet another opportunity for this process exists relative to additive manufacturing support structures. Support structures that are made of an independent material from the model material, are commonly used to support subsequent layers of model material as the model is built up in layers. When the model build is complete, the support structure material is removed to expose overhangs and undercuts in the model. When the support structure material is made of a solid powder and binder combination, the tracing laser can be used to remove a substantial portion of the binder after the support material has been extruded into place to make the removal of that support structure easier once the build is complete.

### BRIEF DESCRIPTION OF DRAWINGS

FIG. 1—Multi-tool fabrication machine without any tools installed. The fabrication apparatus 1 consists of an electronics cabinet 2 that contains such items as a power supply, computer, and relays. The electronics cabinet 2 coordinates the movement of the X-Axis 3, Y-Axis 4, and Z-Axis 5. The coordinated motion of the three axes provide controlled relative positioning of the build platform 6 to the tool carriage 7.

FIG. 2—Extrusion tool 8 and laser tool 9 mounted in the tool carriage 7. The extrusion tool 8 is depositing model material in paste form onto the surface of a partially built model 10.

FIG. 3—Extrusion of model material in paste form 12 from the material extrusion device 11 through the extrusion nozzle 13 to form a bead of extruded model material 14.

FIG. 4—Subsequent steps of extrusion then laser trace showing the extruded model material 14 being transformed by the laser tool 9 into cured model material 15.

### PROCESS DETAILS

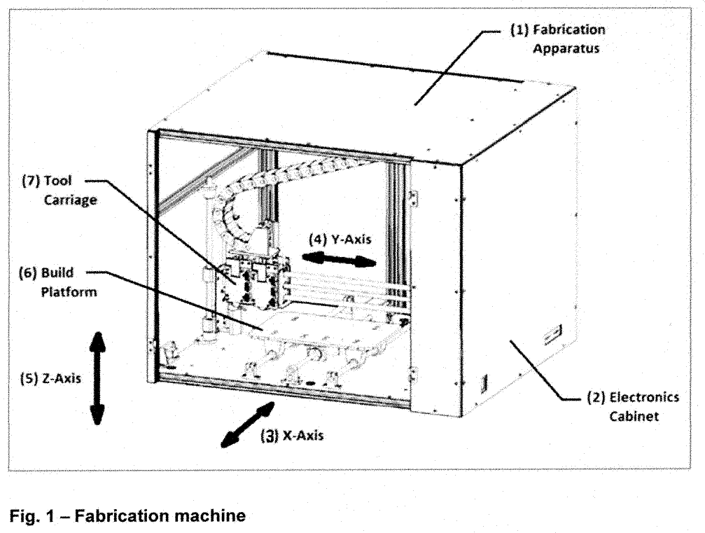

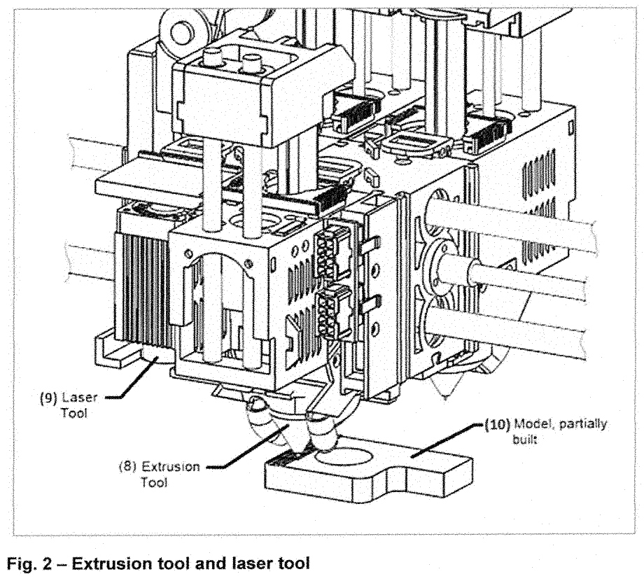

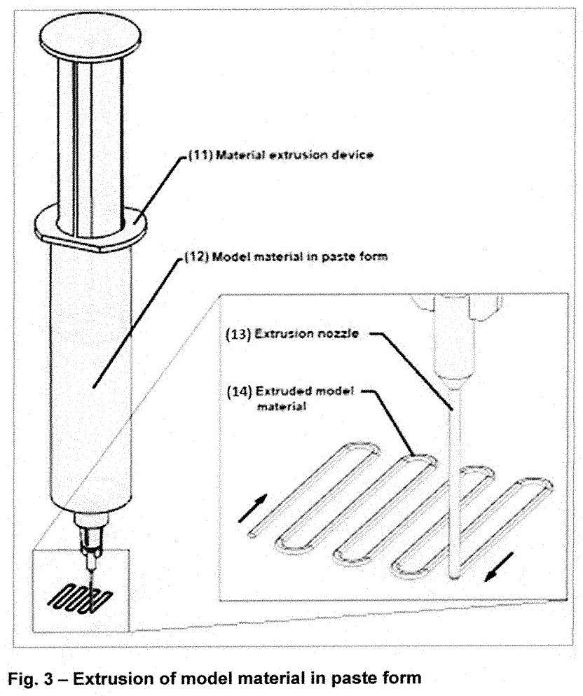

An apparatus such as the one shown in FIG. 1 can be used to execute this process. It contains an electronics cabinet 2 that houses power regulation components, a computer, and various other electronics for controlling the components of the machine. The electronics control stepper motors that can position the tool carriage 7 in the X-Axis 3, Y-Axis 4, or Z-Axis 5 relative to the build platform 6. FIG. 2 shows what the embodiment of both the extrusion tool 8 and laser tool 9 may look like. The extrusion tool 8 is nothing more than a motorized way of controlling the squeezing of a syringe with model material paste in it through an extrusion nozzle. There are a variety of other ways, such as air pressure, gear pump, or peristaltic pump could be used to push material out of the extrusion nozzle. FIG. 3 demonstrates this concept. The material extrusion device 11 fits into the extrusion tool 8 where model material in paste form 12 is squeezed out of it through an extrusion nozzle 13 to form a bead of extruded model material 14 as the electronics position the tool in accordance with the shape of the desired target model data.

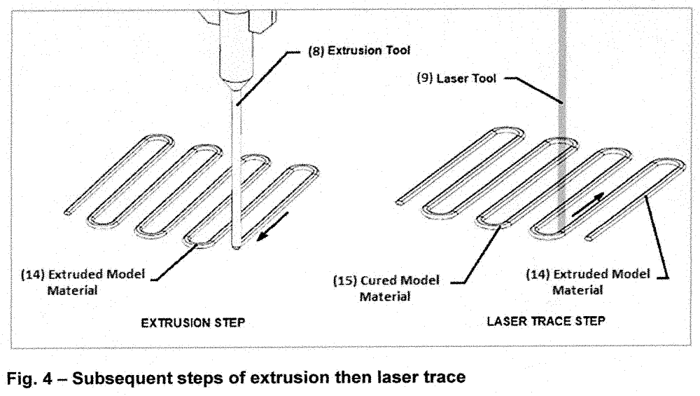

As seen in FIG. 4, once an extruded model material 14 bead has been formed, and before it is covered with a subsequent bead of material, a laser tool 9 generates a laser beam that traces along the same deposition path to alter the properties of the model material in paste form 14 changing it, in this case, to cure model material 15.

Once all the material in the layer has been deposited by the extrusion tool 8, and has been traced by the laser tool 9, the tool carriage increments the thickness of one layer in the Z-Axis 5 and the next layer of the partially built model 10 is deposited and traced in the same manner.

1. A computer controlled additive manufacturing process in which a non-polymer model material consisting of micron sized powder and a non-polymer liquid binder are combined to form a paste that is extruded into the volume enclosed by the target model after which a laser beam of sufficient energy is guided along the same extrusion path to alter the model material's physical properties.

2. The process in claim 1 in which the laser transition action assists in bonding the non-polymer model material in paste form to the surrounding material as its physical properties are altered.

3. The process in claim 1 in which the target model material consists of between 60 and 90 percent micron sized powder combined with 40 to 10 percent liquid binder, by weight, to form the target model material paste.

4. A computer controlled additive manufacturing process in which a non-polymer support structure material consisting of micron sized powder and non-polymer liquid binder combined to form a paste that is extruded into the volume needed to support future model material extrusion after which a laser beam of sufficient energy is guided along the same extrusion path to alter support material's physical properties.

5. The process in claim 4 in which the laser transition action assists in bonding the non-polymer support material in paste form to the surrounding material as its physical properties are altered.

6. The process in claim 4 in which the non-polymer support material consists of between 60 and 90 percent micron sized powder combined with 40 to 10 percent of liquid binder, by weight, to form the target support material paste.

7. A computer controlled additive manufacturing process in which a non-polymer paste is extruded into the volume enclosed by the target model after which a laser beam of sufficient energy is guided along the same extrusion path to alter the physical properties of the previously deposited paste.

8. The process in claim 7 in which the laser energy is sufficient to reduce the liquid content of the deposited paste.

9. The process in claim 7 in which the laser transition action assists in bonding the paste material to the surrounding material as it is altered.

10. The process in claim 7 in which the laser transition action changes the flavor of the previously deposited paste material.
